(19) United States
(12) Patent Application Publication
(10) Pub. No.: US 2017/0169373 A1
(43) Pub. Date: Jun. 15, 2017

(54) SYSTEM AND METHOD FOR MEASURING PERCEIVED IMPACT OF SCHEDULE DEVIATION IN PUBLIC TRANSPORT

(71) Applicant: Xerox Corporation, Norwalk, CT (US)

(72) Inventors: Frédéric Roulland, Le Versoud (FR); Luis Rafael Ulloa Paredes, Meylan (FR); John C. Handley, Fairport, NY (US)

(73) Assignee: Xerox Corporation, Norwalk, CT (US)

(21) Appl. No.: 14/967,723

(22) Filed: Dec. 14, 2015

(51) Int. Cl. G06Q 10/06

(52) U.S. Cl. CPC G06Q 10/06313

(57) ABSTRACT

A method for computing a metric for evaluating reliability of a transportation service includes collecting transportation data for at least a part of a transportation network. For at least one of the stops on at least one route of the network, dimensions of the metric for evaluating reliability are computed. The dimensions are selected from: a) a perceived waiting cost, b) a cost of lateness at a final destination, based on a difference between a scheduled arrival time and an actual arrival time; and c) an annoyance cost due to a missed connection at the stop. A representation of at least one of the computed dimensions is generated for at least one of the stops, for at least one of the passengers and is output.

### BACKGROUND

The exemplary embodiment relates to transportation networks and finds particular application in connection with a system and method for predicting the impact on travelers of deviations from an existing public transportation schedule.

Preserving a sustainable plan for mobility is a growing challenge in larger cities as they continue to grow economically and demographically. Larger urban areas and greater economic activity lead to increases in mobility demand which often result in traffic congestion, longer travel times, and increased pollution. City transportation planners promote the use of public transportation as an efficient way to reduce traffic congestion in dense areas. However, in order to increase adoption, these public transportation offerings should provide potential users with competitive services.

In many countries, where travelers have the option to use a personal vehicle, public transportation is subject to market forces, and thus transportation providers need to provide a high quality of service in order to attract and retain travelers who have a choice of transportation.

Reliability, in terms of how certain a traveler is to arrive at the destination at the expected time, is one performance criterion for transportation services. It consistently ranked high among the reasons people choose to take public transportation. Reliability is often measured through schedule adherence of vehicle trips or headway variations in high frequency trips, such as for the subway at peak hours. Whilst this metric is appropriate to measure the service accomplished by an operator or even by a bus driver, it does not always reflect what is actually perceived by a traveler. The reasons for the use of this metric are often technical, since only a few transportation authorities are currently able to follow individual passenger travels, because there is no data and/or no system in place to do so. Political reasons may also exist. For example, the transportation authority may have service level agreements with private transportation providers that are based on this metric, with provisions for the payment of fines when the provider does not meet specified metrics. Transportation authorities may also fear customer distrust if they attempt to measure traveler satisfaction.

In practice, travelers often use a combination of public transport routes (lines) to move from an origin to a final destination. The impact of schedule variations can have a compound or a negligible effect, depending on the traveler's planned schedule. As an example, consider the case where a traveler's first vehicle is five minutes late. The impact will be lessened if the traveler normally has to wait ten minutes before taking another vehicle for the next connection. However, if the next vehicle of the connecting line is missed, the impact can increase dramatically, particularly if it is the last trip of the day. Another consideration is the frequency of the service. A high frequency service, e.g., one vehicle every 5 minutes, will reduce the impact in terms of waiting time in a connection. In the aggregate, a vehicle fully loaded of passengers will impact many people whereas an empty vehicle will have no impact.

While most studies focus on schedule time variations, there have been several proposals for measuring the waiting cost associated with a public transit service. See, for example, P. G. Furth, et al., “Service Reliability and Hidden Waiting Time: Insights from AVL Data,” Transportation Research Record, 2006; A. Ceder, “Public Transit Planning and Operation, Theory, Modelling and Practice,” Elsevier (2007); R. G. Mishalani, et al., “Passenger Wait Time Perceptions at Bus Stops: Empirical Results and Impact on Evaluating Real-Time Bus Arrival Information,” J. Public Transportation, Vol. 9, No. 2, 2006. H. H. Panjer, “Operational Risk: Modeling Analytics,” Wiley, 2006, describes general approaches to assessing the impact of decisions in the presence of uncertainty. These methods however, are based only on schedule adherence data. They therefore consider flows of people with assumptions on their distributions. The method of Furth, for example, makes the assumption that the number of passengers waiting at a bus stop is uniform across a day. In reality, public transportation traffic is heterogeneous, with one or more peak periods each day.

There remains a need for a method for measuring the reliability of public transport services that captures the impact on passengers better than the schedule deviation of a single vehicle.

### INCORPORATION BY REFERENCE

The following references, the disclosures of which are incorporated herein by reference in their entireties, are mentioned:

U.S. Pub. No. 20130185324, published Jul. 18, 2013, entitled LOCATION-TYPE TAGGING USING COLLECTED TRAVELER DATA, by Guillaume M. Bouchard, et al.

U.S. Pub. No. 20130317742, published Nov. 28, 2013, entitled SYSTEM AND METHOD FOR ESTIMATING ORIGINS AND DESTINATIONS FROM IDENTIFIED END-POINT TIME-LOCATION STAMPS, by Luis Rafael Ulloa Paredes, et al.

U.S. Pub. No. 20130317747, published Nov. 28, 2013, entitled SYSTEM AND METHOD FOR TRIP PLAN CROWDSOURCING USING AUTOMATIC FARE COLLECTION DATA, by Boris Chidlovskii, et al.

U.S. Pub. No. 20130317884, published Nov. 28, 2013, entitled SYSTEM AND METHOD FOR ESTIMATING A DYNAMIC ORIGIN-DESTINATION MATRIX, by Boris Chidlovskii.

U.S. Pub. No. 20140201066, published Jul. 17, 2014, entitled SYSTEM AND METHOD FOR ENABLING TRANSACTIONS ON AN ASSOCIATED NETWORK, by Pascal Roux, et al.

U.S. Pub. No. 20140089036, published Mar. 27, 2014, entitled DYNAMIC CITY ZONING FOR UNDERSTANDING PASSENGER TRAVEL DEMAND, by Boris Chidlovskii.

U.S. App. Ser. No. 14/737,964, filed Jun. 12, 2015, entitled LEARNING MOBILITY USER CHOICE AND DEMAND MODELS FROM PUBLIC TRANSPORT FARE COLLECTION DATA, by Luis Rafael Ulloa Paredes, et al.

U.S. Application Ser. No. 14/450,628, filed Aug. 4, 2014, entitled EFFICIENT ROUTE PLANNING IN PUBLIC TRANSPORTATION NETWORKS, by Ulloa Paredes.

### BRIEF DESCRIPTION

In accordance with one aspect of the exemplary embodiment, a method for computing a multidimensional metric for evaluating reliability of a transportation service. The method includes collecting transportation data for at least a part of a transportation network, the network including a set of routes that are traversed by vehicles, each route including a set of stops. For at least one of the stops on the at least one route, dimensions of a multidimensional metric for evaluating reliability are computed. The dimensions are selected from: a perceived waiting cost, a cost of lateness at a final destination, and an annoyance cost due to a missed connection at the stop. The perceived waiting cost is a measure of annoyance caused for a passenger waiting at the stop for a vehicle. The cost of lateness at a final destination is based on a difference between a scheduled arrival time and an actual arrival time, the scheduled arrival time taking into account a theoretical time for making each connection, if any. The annoyance cost due to a missed connection at the stop is computed as a function of a difference between a time of arrival at the final destination of the vehicle that was actually taken by the passenger and the arrival at the final destination of the vehicle that would have been taken, had there not been a missed connection. A representation of at least one of the computed dimensions is generated for at least one of the stops, for at least one of the passengers; and is output.

One or more of the steps of the method may be performed with a processor.

In accordance with another aspect of the exemplary embodiment, a system for computing a multidimensional metric for evaluating reliability of a transportation service includes a data collection component, which collects transportation data for at least a part of a transportation network. The network includes a set of routes that are traversed by vehicles, each route including a set of stops. A lateness component computes distributions of lateness of vehicles at some of the stops on at least one of the routes, based on scheduled arrival times and determined arrival times. A reliability computation component, for a plurality of stops on the at least one of the routes, computes dimensions of a multidimensional metric for evaluating reliability. The dimensions include a perceived waiting cost, which is a measure of utility based on the annoyance caused for a passenger waiting at the stop for an expected vehicle, a cost of lateness at a final destination, based on a difference between a scheduled arrival time and an actual arrival time, the scheduled arrival time taking into account a theoretical time for making each connection, if any, and an annoyance cost due to a missed connection at the stop, which is computed as a function of a difference between a time of arrival at the final destination of the vehicle that was actually taken by the passenger and the arrival at the final destination of the vehicle that would have been taken, had there not been a missed connection. A representation generator generates a representation of at least one of the dimensions for at least one of the stops, for at least one of the passengers and outputs the representation. A processor implements the data collection component, lateness component, reliability computation component, and representation generator.

In accordance with another aspect of the exemplary embodiment, a method for evaluating reliability of a transportation service includes collecting transportation data for at least a part of a transportation network, the network including a set of routes that are traversed by vehicles. Each route includes a set of stops. The transportation data includes scheduled vehicle trips on the network and passenger data. The passenger data includes boarding times and alighting times for passengers at stops on the network. Historical distributions of lateness are computed, based on scheduled arrival times and actual arrival times of vehicles at the stops. For each passenger in a set of passengers, a perceived waiting cost at one of the stops is computed. The perceived waiting cost takes into account the computed distributions of lateness. The perceived waiting cost is a function of: an estimated waiting time component, which is an estimate of the actual time spent waiting at a stop for a vehicle, that takes into account whether the stop is an origin of a journey by the passenger or a connecting stop, a budgeted waiting time component, which is a measure of the time a passenger expects to wait when they have arrived at their final destination, and a stress component, which considers stress factors which influence perceived waiting costs. The method further includes generating a representation of the perceived waiting cost for at least one of the stops, for the set of passengers and outputting the representation.

One or more of the steps of the method may be performed with a processor.

### BRIEF DESCRIPTION OF THE DRAWINGS

FIG. 1 is a functional block diagram of an environment in which a system operates for computing a multidimensional metric of reliability of a transportation service;

FIG. 2 illustrates components of the exemplary system;

FIG. 3 is a flow chart illustrating a method for computing a multidimensional metric of reliability of a transportation service;

FIG. 4 is a representation of passengers' perceived waiting cost for one line (route) of the illustrative transportation network in a given period;

FIG. 5 is a stacked bar chart representation of components of passengers' perceived waiting cost over time (days);

FIG. 6 is a map view representation of number of late buses on line 130 in the same time interval as used for FIG. 4;

FIG. 7 is a graph showing temporal daily distribution of estimated waiting time; and

FIG. 8 is a graph showing temporal daily distribution of boardings;

FIG. 9 is a bar chart showing weekly evolution of perceived waiting cost metric when starting without history,

FIG. 10 is a map view representation of absolute average late arrival of passengers at their final destinations for line 130;

FIG. 11 is a map view showing relative average lateness at final destination for line 130;

FIG. 12 is a calendar chart representation of passengers' late arrival at the final destination;

FIG. 13 is a map view representation of missed connection impact at connections;

FIG. 14 is a calendar chart representation of missed connection impact at a connection;

FIG. 15 is a global map view of number (circle size) and delay impact (circle shade) of missed connections; and

FIG. 16 is a bar graph showing a one day temporal view illustrating the impact of missed connections delay at a stop on the network.

### DETAILED DESCRIPTION

Aspects of the exemplary embodiment relate to a system and method for computing a measure of the reliability of service, as experienced by a set of passengers traveling on a transportation network. The system and method recognize that there are (at least) two components to evaluating the cost of a decision: the expected impact and some measure of uncertainty. For example, the perceived, subjective impact of a traveler's decision to take a certain bus at a certain time includes the expected waiting time and a function of the uncertainty or variability associated with that waiting time. These factors are incorporated into a subjective assessment of passenger annoyance which form one dimension of a multidimensional metric of transportation reliability.

As used herein the term “cost” indicates any suitable measure of the respective impact and does not necessarily imply a monetary cost.

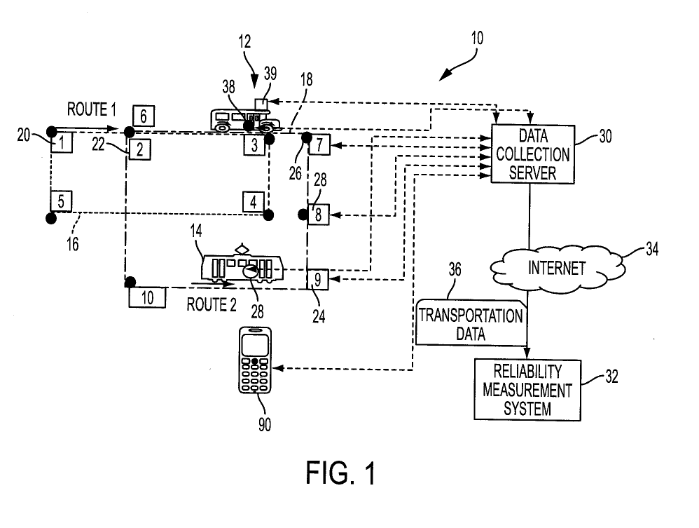

With reference to FIG. 1, an illustrative transportation network 10 includes multiple public transport vehicles 12, 14, etc. The vehicles travel on different routes 16, 18, etc. to provide transportation services that are utilized by a large number of users, which may be referred to as passengers or travelers. Each route may include a set of predetermined stops 20, 22, 24, etc. (such as stations, bus stops, or tram stops), at fixed locations on the route, where passengers can board or alight from a vehicle. The transportation network 10 may include a set of automatic ticketing validation (ATV) devices 26, 28, etc., that collect validation information for travelers and a data collection server 30 which collects the information from the ATV devices. The ATV devices 26, 28 may be associated with the stops on the routes or with the vehicles themselves. The data collection server 30 is communicatively connected with a reliability measurement system 32, e.g., via a wired or wireless link 34, such as a telephone line, local Area Network, or a Wide Area Network, such as the Internet, for providing transportation data 36 to the reliability system 32. In other embodiments, the ATV devices may communicate directly with the system 32 for providing transportation data 36 to the system. In some embodiments, the vehicles may include automated passenger counting (APC) devices 38, e.g., located at the door(s) of the vehicles. Each of the vehicles may include an automated vehicle location (AVL) component 39, which provides the data collection server 30 with information on the vehicle's arrival and departure times for each stop along the route.

The transportation network 10 may be a bus, rail, tram, or subway network, or may include a combination of two or more different modes of transport.

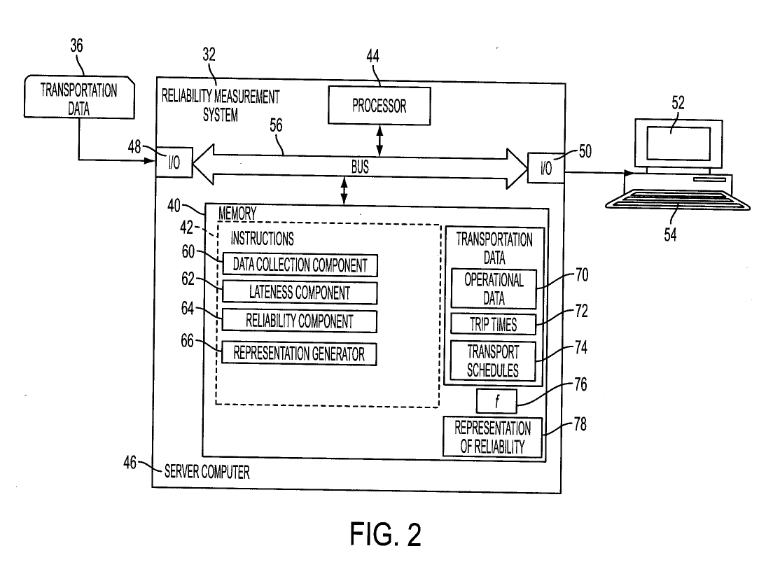

With reference now to FIG. 2, the reliability measurement system 32 computes a measure of the reliability of service of transportation, as experienced by passengers of the transportation network 10. The system 32 includes memory 40 which stores software instructions 42 for performing a method of reliability measurement and a processor 44 in communication with the memory for executing the instructions. The system may be resident on one or more computer device, such as the illustrated server computer 46. One or more input/output devices 48, 50 allow the system to communicate with external devices, such as the data collection server 30, a display device 52, and a user input device 54, such as a keyboard, keypad, touch screen, cursor control device, or combination thereof. Hardware components 40, 44, 48, 50 of the system 32 may be communicatively connected by a data/control bus 56.

Briefly, as illustrated in FIG. 2, the instructions 42 may include a data collection component 60, a lateness component 62, a reliability component 64, and a representation generator 66.

The data collection component 60 collects transportation data 36 which may include operational data 70 recording the number of passengers getting on and off at each stop, trip times 72 of individuals (or data from which this is computed by the system), and transport schedules 74 for the routes of the network.

The lateness component 62 computes historical distributions of lateness as a function of stop and time interval (time of day and day of the week).

The reliability component 64 computes a measure of the reliability (three-dimensional metric) of the transportation service provided by the network 10 using a function f 76 which takes as input, the historical lateness distributions, passenger counts, and trip times for passengers according to three dimensions: perceived waiting cost, impact of missed connections and lateness at final destination.

The representation generator 66 generates a representation 78 of the reliability of the transportation network, or a part thereof, to display one or more dimensions of the metric 76, computed spatially (e.g., showing more than one stop) and/or temporally (showing more than one time interval). The representation 76 may be in the form of a graphical user interface. This may allow decision makers to interact with the data and/or adjust parameters of the existing transportation system. The output 76 of the system may be used, for example, to direct allocation or reallocation of resources, including changing schedules of run times, addition or reduction of vehicle capacity, adding or removing stops and/or to make changes in operations to reduce headway variance through communication to drivers/operators, traffic signal prioritization, and the like.

The computer system 10 may include one or more computing devices 46, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 40 may represent any type of non-transitory computer readable medium such as random access memory (RAM), read only memory (ROM), magnetic disk or tape, optical disk, flash memory, or holographic memory. In one embodiment, the memory 40 comprises a combination of random access memory and read only memory. In some embodiments, the processor 44 and memory 40 may be combined in a single chip. Memory 40 stores instructions for performing the exemplary method as well as the processed data 76, 78.

The network interface 48, 50 allows the computer to communicate with other devices 30, 52 via a computer network, such as a local area network (LAN) or wide area network (WAN), or the Internet, and may comprise a modulator/demodulator (MODEM) a router, a cable, and/or Ethernet port.

The digital processor device 44 can be variously embodied, such as by a single-core processor, a dual-core processor (or more generally by a multiple-core processor), a digital processor and cooperating math coprocessor, a digital controller, or the like. The digital processor 44, in addition to executing instructions 42 may also control the operation of the computer 46.

The data collection server 30 may be any suitable computing device or devices. It may be similarly configured to the computer 46, e.g., with memory and a processor which executes instructions for collecting and storing transportation data, preprocessing it (optional) and communicating at least a part of the collected/processed transportation data 36 to the system 32.

The display device 52 may be a screen, computer monitor, or the like and may be a part of a separate computing device or connected directly to the computer 46.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

In the exemplary system, the measure of the reliability of a public transportation service is computed using a combination of three dimensions that capture how the reliability of the service is perceived by travelers. Rather than considering only schedule deviation, the exemplary system considers lateness and the impact of missed connections.

The first dimension is a perceived waiting cost, which captures the annoyance caused by a vehicle not being on time for people waiting at the stop. The perceived waiting cost may be computed for each user and aggregated at the stop location where the users board.

The second dimension is a lateness at final destination and captures the annoyance caused to a person arriving later than expected. The lateness at the final destination may be computed for each user and is aggregated at the stop where they last alighted during their trips.

The third dimension is a measure of missed connections and captures the overall lateness at the final destination caused by a first vehicle arriving late or a second vehicle leaving early at a given connecting stop.

The system is not limited to three dimensions, however, and may consider other factors in computing the measure of reliability, such as the weather or time of day when a delay occurred, which may impact the travelers' perceptions of reliability.

The three dimensions can be represented spatially as a visualization built on top of a suitable Geographical Information System (GIS).

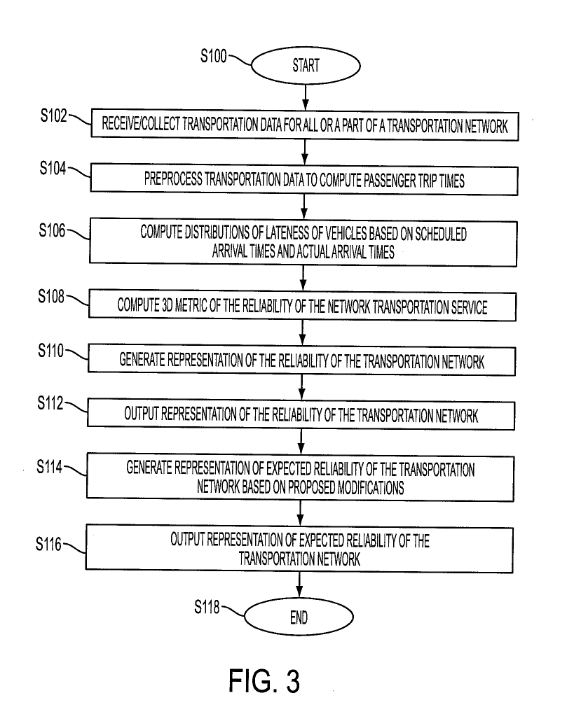

FIG. 3 illustrates a computer-implemented method of computing a measure of the reliability of a transportation service which may be performed with the system of FIG. 2. The method begins at S100.

At S102, transportation data 36 is received by the data collection component 60 and may be stored in memory 40.

At S104, the transportation data 36 may be preprocessed, by the data collection component 60, e.g., to compute trip times 72 of individual passengers from origin and destination information.

At S106, historical distributions of lateness are computed as a function of stop and time (e.g., time of day, day of the week), by the lateness component 62.

At S108, a measure of the reliability in the form of a three dimensional metric of the transportation service provided by the network 10 is computed, by the reliability component 64, using function f 76 which takes as input, the historical lateness distributions, passenger counts, and trip times for passengers according to three dimensions: perceived waiting cost, impact of missed connections and lateness at final destination.

At S110, a representation 78 of the reliability of the transportation network, or a part thereof, in terms of one or more of the three dimensions, is generated by the decision support component 66.

At S112, the representation 76 is output from the system, e.g., to display device 52 or to remote memory accessible to the display device.

At S114, proposed modifications to parameters of the transportation system may be received by the system 32 and used, by the decision support component 66, to generate a modified representation of an expected measure of the reliability of the transportation service. The modifications of parameters may include modifications to direct allocation or reallocation of resources, including changing schedules of run times, addition or reduction of vehicle capacity, adding or removing stops, changes in headway variance, and the like.

At S116, the modified representation may be output from the system, e.g., to display device 52 or to remote memory accessible to the display device.

The method ends at S118.

Further details of the system and method will now be described, with particular reference to the type of data 32 that is collected and used in order to compute the reliability metrics. Details of the computation and an exemplary GIS representation are also described.

Vehicles on the transportation network make vehicle trips. Each vehicle trip entails travel between a set of stops on a given route from a first stop to a last stop.

Passengers on the transportation network make journeys between an origin and a destination. Each journey may include one or more trips on different routes. Where two (or more) trips occur within a short space of time, it is assumed that the user is making a connection and thus the two trips form a single journey. For example, in FIG. 1, a passenger may board a bus 12 on route 1 at stop 1, validating her ticket at ATV device 20, alight at stop 2, and board a tram 14 on route 2, at stop 6 shortly thereafter, validating her ticket at ATV device 22 and alight at stop 9. The same ticket may be used for both trips.

Tickets used by passengers can be tangible, e.g., paper or card, or electronic, for example, stored on a smart-phone. Some tickets may be single trip tickets, which do not allow connections. Others may be connecting tickets, which allow connections to be made within a predefined period, such as an hour. Other tickets are multi-trip tickets allowing a fixed maximum number of trips (or journeys if connections are permitted). Other tickets are valid for a fixed time period, such as a week or month, allowing any number of trips or journeys within that time period.

The tickets may be validated when the passenger boards a vehicle or shortly before or after boarding. Validation may include associating a time stamp with the ticket. For example, the ticket may be validated when the passenger passes through a turnstile 26, 28 on the way to board a train, at an ATV device 26, 28 that is in a fixed location at a bus or tram stop, or as the user boards a bus or tram, using an ATV device 26, 28 which is transported by the vehicle. In the case of tickets purchased on the vehicle, the validation may occur at the time of purchase. The ticket machine can thus serve as an ATV device 26, 28. In the case of tickets which permit more than one trip to be made, subsequent trips can be associated with the same passenger using a ticket identifier.

Different types of ticket validation may be used. Some validation systems are “check-in only.” These associate a check-in location and check-in time (approximate boarding time) with the ticket ID, but provide no check-out (alighting) information. In the case of tickets which permit more than one trip to be made, assumptions can be made about the check-out location based on subsequent trips recorded for that ticket ID. For example, if a passenger using a multi-journey ticket makes a trip later in the same day on the same route, the origin for the return trip can be assumed to be the destination of the earlier trip, and the origin of the first trip can be assumed to be the destination of the second, i.e., return trip. For multi-day tickets, the first trip of the next day may be assumed to start at the destination of the previous day's last trip.

Some validation systems are “check-out only.” These associate a check-out location and check-out time (approximate alighting time) with the ticket ID, but provide no check-in (boarding) information. Assumptions can be made as for the check-in only systems.

Other validation systems are “check-in/check-out,” i.e., validation is performed at both boarding and alighting, providing a time stamp and location for each.

The information from validation devices located on the transportation routes are sent to the data collection server for collection and/or processing.

Missing information (such as alighting times for ticket holders for which only check-in information is available) can be deduced as described above where two or more trips can be tied to the same ticket ID. In the case of single trip or connecting tickets, predictions can be made about the check-out location and time for their ticket holders, based on the behavior of other passengers on the same vehicle trip. This assumes that the population of single trip and connecting ticket users has the same distribution of alighting locations as the passengers for which this information is available or which can be deduced. See, for example, U.S. Pub. Nos. 20130317742 and 20130317884 for a further description of methods for deducing and predicting missing validation information.

In some instances, validation information may be sent from user's smart phones to the data collection server. For example, as described in U.S. Pub. No. 20140201066, in an electronic ticketing system, an ATV device 28 on the vehicle transfers validation information and payment information to a passenger's smart phone 90 using short range communication when the passenger contacts the ATV device 28 with the phone. In turn, the smart phone relays the information to the data collection server 30. To reduce the risk of fraud, the validation information for several passengers may be transferred at the same time.

### Data Collection (S102)

In order to compute the three dimensional metric, access to the following data is provided by the data collection component 60:

Boardings: A count of the passengers boarding at a given stop of a given vehicle trip on a route of the public transportation network 10, for each of a set of stops and vehicle trips. The boarding information can be collected, for example, from passengers' logs, check-in validations from the ATV device 26, 28, or from automatic passenger counting (APC) systems 38, which may be located at the door of the vehicle.

Alightings: As for the boardings, these are each a count of the passengers alighting at each stop of each vehicle trip of the public transportation network 10. This information can be collected from APC 36 systems or, if the service is equipped with a check-in/check-out fare collection system, can be obtained from the check-out validations. If neither of these systems is available but there is a check-in fare collection system, an estimate of the alighting information can be computed using the methods described above and in U.S. Pub. Nos. 20130317742 and 20130317884.

As will be appreciated, the boarding and/or alighting counts may be an actual count or may be an estimated count where missing information is deduced and/or predicted.

Passenger journeys: these represent the journey of the passenger from origin to final destination, and can include transfers between routes on the network. A passenger journey can be captured through the collection of all boarding and alighting times at respective stops, by the passenger in a short sequence of time. The information for identifying these journeys can be obtained directly from the logs of a check-in/check-out validation system 26, 28. Alternatively, they can be estimated for a check-in validation system, based on outbound and return journeys of the same passenger, as described, for example, in U.S. Pub. Nos. 20130317742 and 20130317884.

Scheduled vehicle trips: these are obtained from the planned schedules 74 of the public transportation service. This information is usually public and often available in formats such as the General Transit Feed Specification (GTFS: https://developers.google.com/transit/gtfs/reference), which defines a common format for public transportation schedules and associated geographic information that is computer-readable.

Real vehicle trips: these provide the actual trip timing that was followed by each vehicle. This information is what is conventionally used to measure the schedule adherence. It can be obtained from an Automated Vehicle Location (AVL) component 39 on board each vehicle, which tracks the vehicle's location over time, allowing the time at each of the stops of a vehicle trip to be computed. The AVL component 39 provides arrival and departure time for each stop. The real trips may also or alternatively be estimated using the theoretical schedule and check-in data. For example, if a bus trip is scheduled to leave a stop at a given time, but none of the passengers validating their tickets on the bus after that stop does so until ten minutes later, it can be deduced that the bus was about ten minutes late.

At a minimum, therefore, the exemplary system and method have available check-in (or check-out) validation information and a definition of the public transit network and its associated schedule. Using this information, the system computes perceived waiting cost, missed connections, and lateness at final destination.

### Historical Distributions of Lateness (S106)

The lateness component 62 computes historical distributions of lateness for each stop and time interval (time of day and day of the week). Thus for example, for each stop 20, 22, 24, the week, or other time period, is partitioned into shorter time intervals, such as a half hour, an hour, or the like. The time intervals may be of equal length. For each time interval, the vehicles arriving at the stop within the time interval are identified, e.g., from the real vehicle trip data received from the AVL components 39. For each of these vehicles, the lateness is computed, by comparing the vehicle arrival time with the scheduled arrival time, obtained from the transport schedules 74. The distribution of schedule variations for each stop on a route can then be obtained.

### Computing the Three Dimensional Metric (S108)

Each of the following dimensions may be computed:

1. Perceived Waiting Cost

The perceived waiting cost PWC is a measure of utility based on the annoyance caused by a vehicle not being on schedule (the planned schedule or in practice, based its historical lateness) for a passenger waiting at a stop.

The exemplary PWC may be computed as a function of three components: an estimated platform waiting time EW, a budgeted waiting time BT and a stress component SC, although fewer, more or different components may be considered.

i. Estimated Waiting Time

The EW is an estimate of the actual time spent waiting at a stop for a vehicle. The actual platform waiting time is directly measurable. The collected transportation data 36 provides an estimate of when a vehicle arrives at a stop. However the time at which each traveler arrived at a stop is unknown. The maximum waiting time can be computed as the difference between the arrival of the vehicle boarded and the previous vehicle offering the same alighting stop, which is referred to as the headway between two vehicles. Reasonable assumptions can be used to model the waiting time by considering two different situations.

a) When people are waiting for a vehicle on a service route which is of high frequency, it may be assumed that they do not consult the schedule and therefore the EW can be modeled as a probability distribution, e.g., a uniform distribution between zero and the maximum waiting time. The maximum likelihood estimate for the waiting time of one user may be assumed to be:

EWᵢ=0.5 Hᵢ

where:
EWᵢ is the maximum likelihood estimate of waiting time for the time interval i between arrival of two vehicles of the same route at the stop where the passenger was waiting.
Hᵢ is the duration of the interval i.

b) When people are waiting for a service line of low frequency, it may be assumed that they consult the schedule in order to reduce their waiting time. It may also be assumed that they are regular users which have a prior knowledge of the stop arrival distribution. In addition, it may be assumed that the passengers anticipate that the bus would be early or late with respect to the scheduled time, based on their knowledge of the past schedule variation of the service. In this case the waiting time may be estimated according to:

EWᵢ=max(Vᵢ−Vₚ, 0)

where:
EWᵢ is the estimated waiting time for the time interval i between arrival of two vehicles of the same route at the stop where the user was waiting.
Vᵢ is the variation from the schedule of the service for the interval i.
Vₚ₁ is the p₁^{th} percentile of the distribution of schedule variation for this service.

This formula assumes that passengers would like to arrive exactly on time to catch the bus, i.e., EWᵢ=0, although this is generally not true in practice. Thus, a constant waiting time could be used in place of 0.

This formula combines the actual schedule variation of that day with an additional waiting time that corresponds to a situation where a user of the service will be sure to catch the bus in 100-pᵢ % of the time when looking at the history. This amounts to an additional waiting time if the bus is early more than p₁ % of the time and a lesser waiting time if it is always late. This assumes that passengers will arrive at the stop at a time before the vehicle is expected to arrive most of the time.

For example, if passengers know that a bus scheduled to arrive at the stop at 8.05, but does not arrive until 8.10 in at least 95% of the cases, then the passenger will tend to arrive later than they would have done if the bus kept to the schedule.

In determining which situation to consider, the minimum value from the two computations may be used:

EWᵢ=min (0.5 Hᵢ, max ((Vᵢ−Vₚ₁, 0))

c) Estimated Waiting Time for Passengers with Connections

The above computations of EW are applicable for the case when passengers are beginning their journey. For a passenger connecting between two trips, the estimated waiting time EW can be computed as the actual waiting time. This can be computed from the actual connection time minus the walking time estimated for that making that connection.

ii. Budgeted Waiting Time

The BT is a measure of the time a passenger expects to wait when they have arrived at their final destination. This assumes that passengers want to arrive no later than a given time, so they will budget extra time, based on past experience, to be sure to arrive on time.

In order to model BT for a given user, the historical distribution of late arrival is considered and the p₂ percentile taken. This implies that a user assumes that potential amount of delay at the final destination will enable arriving by a selected time (e.g., of an appointment) a threshold proportion (p₂ %) of the time:

BT=LAₚ₂(D)

where:
BT is the budgeted waiting time for a time interval T for a user going from origin 0 to destination D.
LAₚ₂ is the value of the p₂^{th} percentile of the distribution of late arrival to destination D.

This component assumes that passengers are under some pressure to arrive on time for the activity they will undertake at final destination and that they have a degree of anticipation of the reliability of the service. It may vary from almost no influence for a tourist visiting the city to a high influence for a regular user having an important meeting. This component may therefore be added to the estimated waiting time at the stop with a weight coefficient having a value in the range [0,1] to represent the average user in the population. The weighting coefficient may vary depending on the destination (e.g., stops near tourist attractions may have a lower coefficient than stops near business premises) and/or the time of day (e.g., a higher coefficient for the early morning when people are typically going to work).

iii. Stress Component

The stress component SC captures the expectation that people do not like to wait and may perceive the waiting time differently, depending on the waiting conditions. The stress component considers one or more stress factors which influence perceived waiting cost of a passenger. The stress component may be modeled as a function of three stress factors:

a) Impact of crowd: This is determined as a function of the number N of people waiting at the stop, which is assumed to increase the level of stress for people waiting.

b) Impact of service: This is determined as a function of the scheduled headway Hₜₕ between the previous and the next vehicle of the service. This models the fact that low frequency services increase the level of stress for people having to synchronize with the schedule because of the cost associated with missing one vehicle.

c) Impact of time: This can be determined as a function of the ratio of current number of travelers CT in a time period (such as a day) which includes the time interval i, to a standard number of travelers DT within a same period (such as a day). For example, CT is the number of passengers for at least a part of the network in the day which includes the time interval i, and DT is the yearly maximum number of passengers for the at least a part of the network in a respective day. This assumes that a busy city will be more a source of stress and that certain days/seasons are more stressful than others. The stress component may be computed as an optionally-weighted aggregate of these three components, with respective weights a, b, and c:

where:

$$SC = a * N + b * {H}_{th} + c * \frac{CT}{DT}$$

N is number of passengers waiting at the same time,
Hₜₕ is the theoretical headway between the previous and next vehicle,

$$\frac{CT}{DT}$$

is a measure of the relative business of the network;
a, b, c, are weighting coefficients and may be set, for example, 0<a, 0<b, 0<c, and optionally a+b+c=a fixed value, such as 1, although a user may be allowed to tune the weights, e.g., setting one of them to 0.

For passengers making connections, the stress component may take into account the uncertainty caused by the schedule variations, even if the actual waiting time does not differ significantly from what would have been computed, based on the schedule, or which could be expected, based on historical data.

### Computing the Perceived Waiting Cost

The PWC at a stop for a given period can then be estimated as a function of an optionally-weighted aggregation of the components, as follows.

For each passenger starting at this stop, a sum over all components to define an annoyance factor φ:

φ=[d*EW]+[g*BW]+[SC] (1)

The PWC is then computed as an increasing function of the annoyance factor, e.g.:

$$PWC = {e}^{- α \frac{1}{ϕ}} \qquad ( 2 )$$

where:
φ is the annoyance factor,
EW is the estimated waiting time at the stop,
BW is the budgeted waiting time,
SC is the stress component,
d and g are weighting coefficients, and
α is a risk aversion coefficient.

The risk aversion coefficient can be considered the same for all passengers, such as a value of 0.1-0.99, or may be set differently for different populations of people.

The above formulation provides an exponential cost, although a more linear formulation could be used. The exemplary cost formulation can be considered as a decision measure that ordinally quantifies choice. In economics this is analogous to the standard Neumann-Morgenstern utility (see, John von Neumann, et al., “Theory of Games and Economic Behavior,” Princeton, N.J. Princeton University Press, 1953), where maximization of utility (or minimization of cost) is expected under uncertainty. For example, if a traveler expects bus A to be three times faster but twice as late as B, then, depending on the traveler's risk aversion, A might not always be chosen over B.

### Alternative Waiting Cost: Perceived Waiting Time

In practice, passengers perceived waiting time (cost) is inflated according to a linear function (to an approximation). See, Mishalani, et al., 2006. Thus, a function for perceived waiting time may be included (by passing the expectation operator through a deterministic linear function), E[EW(t)]=β+β₁E[W(t)], and use this instead of φ in the formulation in Eqn. 1. However the approach described above has the benefit of adding some additional components to the PW component which have an impact on perception and are more meaningful to tune for a user of the system.

2. Lateness of Arrival at Final Destination

Each person's lateness at the final destination can be computed by comparing the scheduled arrival time of the last trip (assuming that any connections made by the passenger were on time) and the actual arrival time, based on the actual trips on the actual vehicles taken by the user.

The theoretical time of the journey can be computed by making a request to an available trip planning engine. Alternatively, the two following steps can be considered for each connection of the observed trip sequence:

i) The minimal time t_{C} required for making a connection: This can be inferred from the walking distance between the two stops or documented based on recorded walking times.

ii) From the theoretical schedule, the earliest vehicle V_{ref} that could be taken within a time greater or equal to t_{C} in the second leg can be identified, assuming the vehicle of the first leg arrives on time.

The lateness cost is then the difference between the scheduled arrival time of the user's last trip and the actual arrival time.

3. Missed Connections

This component computes an annoyance cost of missed connections. In order to identify if someone has missed a connection, the minimal time t_{C} required for making the connection is first computed. This may be inferred from the walking distance between the two stops or documented within the network operational data 70.

Then, the theoretical schedule 74 is accessed to identify the earliest second vehicle V_{ref} that could be taken within a time greater or equal to t_{C} in the second leg, assuming the first vehicle of the first leg arrives on time.

The interval between the actual time of arrival of the first vehicle and the actual time of departure of the second vehicle is then computed. If the time interval is lower than t_{C}, then this is a missed connection.

The cost of the missed connection may be expressed as a function of the difference between the time of arrival at the final destination of the vehicle that was actually taken by the passenger and the arrival at the final destination of the vehicle V_{ref} that would have been taken, in theory, had the first vehicle arrived at the connection in time for the connection to be made.

The metrics described above compute a cost experienced by a user at a given time. In the representations of costs aggregated for a stop and a period of time described above, a simple way to aggregate these costs over time and users is to sum or average the cost of these experiences. Alternative formulations of the stop level costs are contemplated. For example, if an estimated cost of waiting X is available, it can be modeled as a random variable with a finite expectation E(X) and variance V(X) (the prototype being normal, but other, thicker tailed distributions are contemplated, such as log normal). X may have an empirical distribution obtained from historical data or simulations. Suitable measures of expected utility U(X) can be expressed as a function of expected cost E(X), a constant λ, and a measure of variance V(X). Three versions, (λ>0) are given by way of example:

$$U ( X ) = E ( X ) + λ V ( X )$$

$$U ( X ) = E ( X ) + {λ [ V ( X ) ]}^{1 / 2}$$

$$U ( X ) = \frac{{λ [ V ( X ) ]}^{1 / 2}}{E ( X )}$$

Further, if X is a perceived loss, for example being late to the traveler's destination, a risk measure can be used for the loss. Let X be a loss, let its cumulative distribution be F (which is skewed in general, not typically normal), the tail value-at-risk for the passenger's perceived loss can be computed as:

$${TVaR}_{p} ( X ) = E [ X \vert X > {x}_{p} ] = \frac{{\int }_{{x}_{p}}^{∞} xdF ( x ) }{1 - F ( {x}_{p} )}$$

This can be formulated as the perception of being, say, xₚ₌20 minutes late (or associated cost) or being late 100 p % of the time. This has some similarity with operational risk. See H. H. Panjer, “Operational Risk: Modeling Analytics,” Wiley (2006).

### Representation (S110, S112)

As described above, the metric 76 used to assess reliability is composed of several dimensions: the perceived waiting cost, the lateness at final destination and the missed connections.

The three values of the dimensions are computed for each passenger at the time of all boarding events for waiting cost, at the time of alighting to a connection for missed connections and at the time of final alighting for lateness at final destination. The three values are computed for each passenger journey and attached to the related event composing the vehicle trip. In one embodiment, an aggregation of these results in three spatio-temporal views described below.

1. Perceived Waiting Costs:

The PWC can be represented in a map view or a time series (calendar) chart. In the map view, the individual waiting costs may be aggregated per stop for a selected time range. For example, each stop may be represented by a shape, such as a circle, with attributes that are indicative of the average perceived waiting cost and the number of boarding events during the time interval. Attributes can include color, shape, size, or a combination thereof. As an example, the stops are represented as circles and the color of the circle represents the average perceived waiting cost and the size of the circle represents the number of boarding events during the time interval. In the time series chart, the waiting cost trends can be visualized for a selection of stops. In the stacked histogram, the trend of each of the components of the perceived waiting cost may be displayed for a selection of stops.

In an exemplary embodiment, the weighting coefficients of the illustrative perceived waiting cost may be tuned by a user according to which component(s) is/are expected to be more important or based on empirical studies that the user has performed. For example, the waiting cost may be expressed as the estimated platform waiting time if all the weighting coefficients in Eqn. 1 are set to 0.

2. Lateness at Final Destination:

The lateness at the final destination can be displayed as a map view or a time series chart view, in absolute mode or relative mode.

In the map view, the individual lateness at final destination events may be aggregated per stop for a selected time range. Attributes of each stop may be shown as described above. In the absolute mode, the color of the circle may represent the absolute average lateness at final definition computed as the sum of the lateness at the final destination divided by the number of people alighting from a late vehicle. The size of the circle represents the number of people alighting from a late vehicle during the time interval. In the relative mode, the color of the circle may represent the relative average lateness at the final destination, computed as the sum of the lateness at final destination divided by the number of people alighting from a late vehicle. The size of the circle represents the number of people alighting from a late vehicle during the time interval.

3. Missed Connections:

The missed connections can be displayed as a map view or a time series chart view. In the map view, the individual missed connections events are aggregated per stop for a selected time range. Attributes of each stop may be shown as described above. For example, the color of each circle represents the average lateness associated with missed connections for each stop, i.e., the sum of the lateness at final destination for every trip where the connection was missed divided by the number of connections missed. The size of the circle represents the number of connections missed during the time interval. In the time series chart, the trends of the sum of the lateness at final destination for every trip where the connection was missed can be visualized for a selection of stops.

The exemplary system and method differ from existing methods in several ways. The approach described in Furth, et al., 2006 makes the implicit assumption that the number of passengers waiting at a bus stop is uniform across the day. In practice, traffic in public transportation is heterogeneous across a day with one or more peak periods. By computing averages based on the load for each interval of time in the day this bias is removed.

The method illustrated in FIG. 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 46, (for example, an internal hard drive of RAM), or may be separate (for example, an external hard drive operatively connected with the computer 46), or may be separate and accessed via a digital data network such as a local area network (LAN) or the Internet (for example, as a redundant array of inexpensive of independent disks (RAID) or other network server storage that is indirectly accessed by the computer 46, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the method. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

In existing methods, the estimated waiting time is usually modelled in the field assuming passenger arriving at a stop with a Poisson Process (see, Ceder, “Public Transit Planning and Operation, Theory, Modelling and Practice,” Elsevier (2007). It is however probable that the passenger arrival process is some non-homogenous Poisson process with an arrival rate which varies by time (peak “rush hour” times, mid-day, early morning dead-zones), and the headway will vary too owing to traffic (harder to keep a constant headway in dense traffic with many boardings and alightings).

In the present method, no attempt is made to build such a model but rather to compute a metric from the actual historical data. However the method could use such a model and learn the distribution of headway and passengers arrivals based on the historical data generated.

The present system and method have advantages over existing methods which cannot make a model at the individual trip level, e.g., by relying on the fare collection data. In addition, by tracking passenger journeys it is possible to distinguish people waiting for a connection from people at the origin of their journey and thus provide a better estimate their actual waiting times. By computing an average based on the load for each interval of time in a day, biases can be removed.

Fare collections systems (ATV devices) and automated vehicle location (AVL) systems are now widely used in the public transportation business. They collect daily hundreds of millions of transactions for their customers. The present system and method make use of this readily available data for computing dimensions of the exemplary reliability metric. The results can help public transport authorities and operators to understand better the mobility demand within a city and the quality of service of their operations. The output of the system can be aggregated into a visual analytics platform which can make use of both fare collection data and AVL system output.

Without intending to limit the scope of the exemplary embodiment, the following examples illustrate the application of the method.

### EXAMPLES

The method described above has been used in a prototype system for modeling transport routes in an existing metropolitan transport network over a two-month time period. The results highlight the benefit of such a system for understanding complex patterns of schedule deviation effects that would be hard to isolate otherwise.

In the configuration of the system, the following parameters settings were used:
1. Value for platform waiting time estimate in low frequency schedule: 2 percentile of schedule deviation distribution.
2. Value for budgeted time estimate: 95 percentile of late arrival at final destination.
3. Weights for waiting cost components:
   a. Budgeted time: 0.1× user value between 0 and 10.
   b. Impact of crowd (Waiting people): 10× passenger value between 0 and 10.
   c. Impact of service (Schedule headway): 0.01× passenger value between 0 and 10.
   d. Impact of time (Network busyness ratio): 10× passenger value between 0 and 10.
4. Waiting cost function: in this experiment only a weighted sum of the different components as a waiting cost function has been performed.
1. Perceived waiting cost
   a. Average platform waiting time and lateness of the vehicle

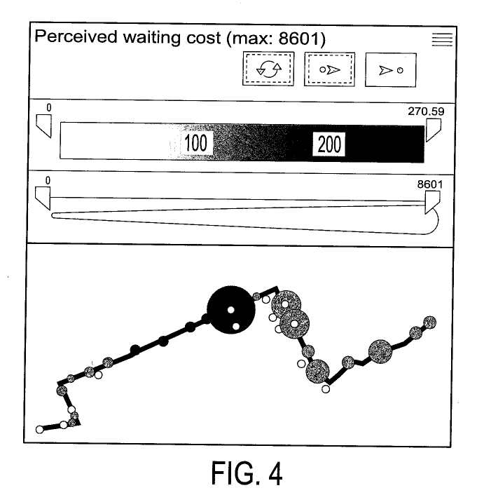

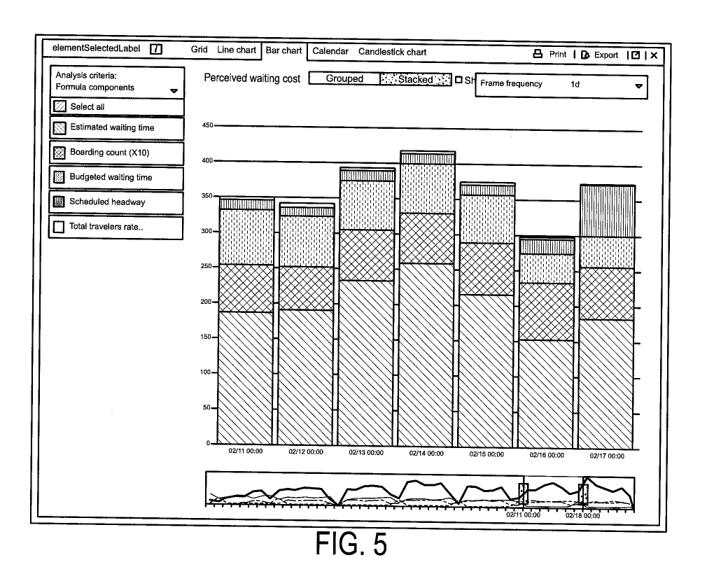

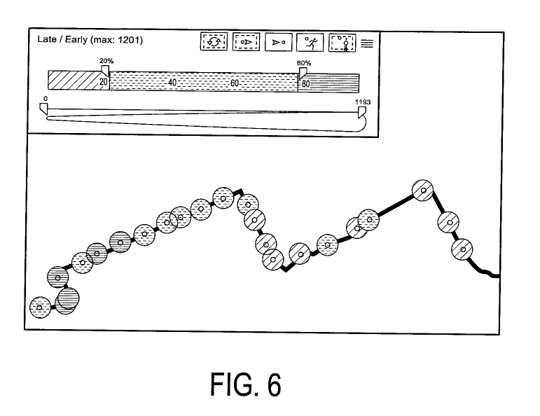

FIGS. 4 and 5 illustrate an example map view (simplified to show part of one route) and a time series chart for perceived waiting cost. FIG. 6 illustrates conventional metrics used to measure schedule adherence by counting the number of trips where the service was late. In FIG. 4, the color coding represents the average waiting platform time and the size of the circle represents the number of passengers boarding at the stop. FIG. 4 emphasizes the value of showing the passenger load together with the waiting cost. This immediately highlights those stations with high boarding number and a high waiting cost which can quickly provide a user with valuable information. As will be appreciated, different colors can be used to emphasize the differences.

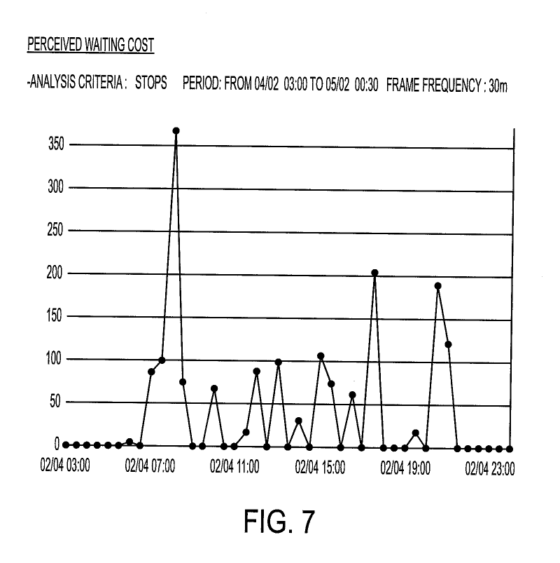

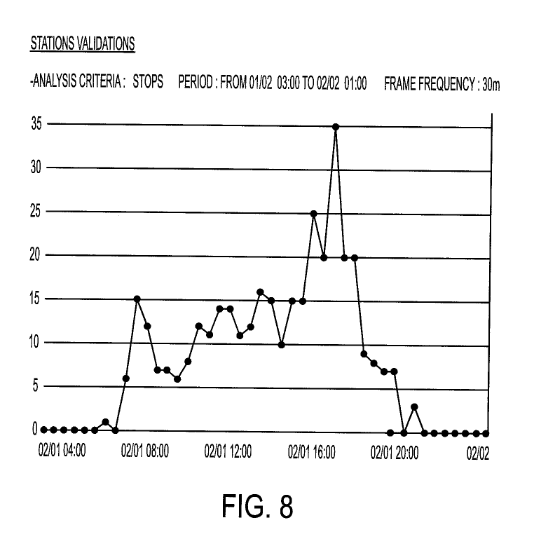

The results also illustrate that there is not always an agreement between the classical late metric, as illustrated in the representation shown in FIG. 6 for part of the route and the average platform waiting time for the same route and time interval, as shown FIG. 4. This is explained by several issues that can better be understood from further analysis at the stop level:
1. The synchronization between late event and peak volume hours: FIGS. 7 and 8 show the temporal daily distribution of estimated waiting time and boardings, respectively at one stop on the route.
2. The effect of users learning when there is a pattern of regular lateness.
3. The effect of higher frequency schedules in part of the route. This is illustrated by FIGS. 4, 6, 7, and 8.
   b. Impact of schedule deviation on the subsequent platform waiting times and budgeted waiting times

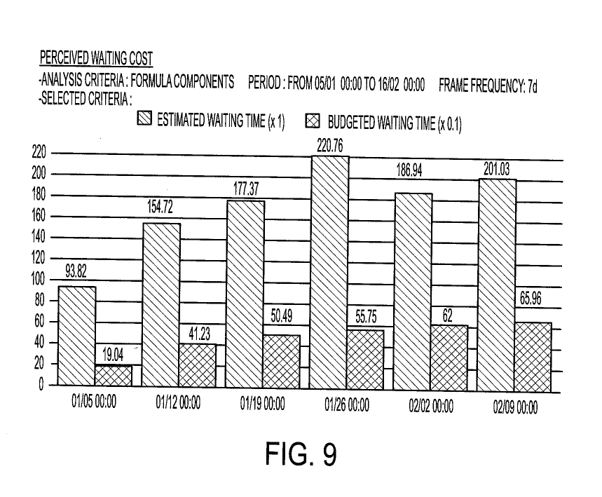

The waiting times (platform and budgeted) are subject to passengers adapting to the history of schedule deviation. As such, the full effects of a service improvement are measured only after few weeks (the period depends on the parameters used for the percentiles to look at in the distribution of schedule deviation). This can be quite visible when looking at the first few weeks of data for the same stop shown in FIG. 9. In this example a bootstrapping artefact in the metric is due the fact that at the beginning, without any history, it is assumed that all passengers will consider that the buses always arrive on time. It can be seen that initially the waiting times are very small but rapidly converge to values that capture the impact of the observed variation of the scheduled deviation over time.
2. Late arrival
   a. Absolute and relative average lateness

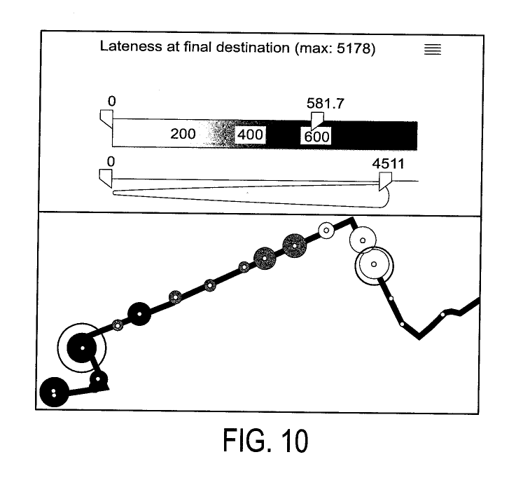

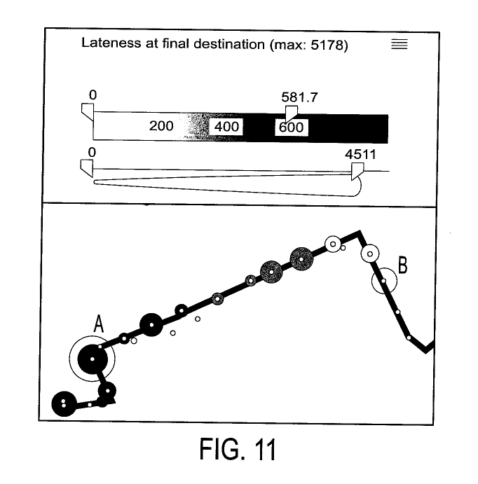

FIGS. 10 and 11 illustrate example map views (simplified) of the absolute and relative average lateness at final destination for part of the route, respectively. On the two maps, the effect of looking at an absolute or relative lateness is apparent. In particular, considering the two stops circled (A on the left end of the line and B on the middle of the line), the propagation of average lateness when going towards the end of the line is clearly seen and the implication on the absolute and relative metrics:

At the stop B, about half of the travelers arrive late. This creates a big difference between the absolute average lateness (85s) and the relative one (167s).

At stop A, the lateness usually propagates and 80% of the travelers arrive late. As such, both metrics increased (301s absolute and 381s relative) but the difference between the two is smaller. This shows that whilst the absolute metric provides a more global comparison between stops, the use of the relative metric is very helpful in places where few buses are late but with potentially quite large delay. In those cases, to consider how people feel they are impacted, the relative metric is more useful.

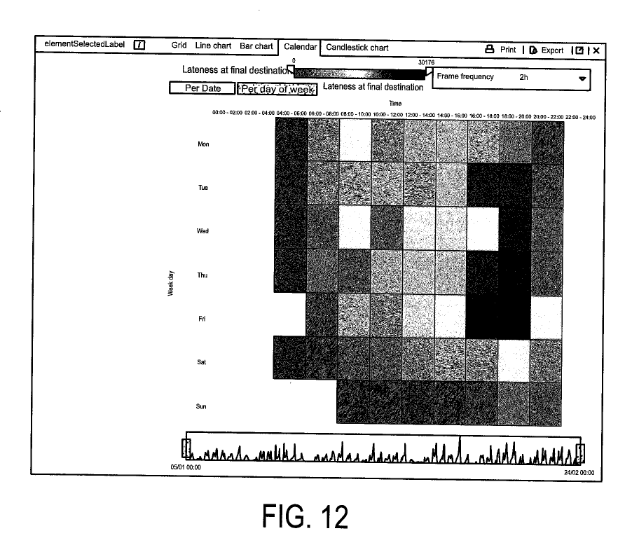

FIG. 12 shows a time series chart for lateness at the final destination. In the time series chart, the sum of the lateness at final destination trends can be visualized for a single stop or for a selection of stops, as shown.
b. Lateness at final destination and lateness of the vehicle

As for the waiting time, the lateness at final destination depends on the correlated temporal effects of schedule deviation and vehicle load. There is, however, another dimension that impacts the results: the missed connections. Although passengers who are late partly because they have missed a connection are limited to 1 or 2% in average, these events happen punctually and can explain some peaks in the temporal changes in this metric.
3. Missed connections:

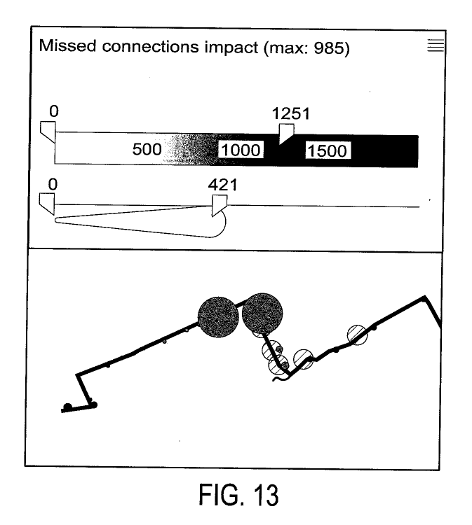

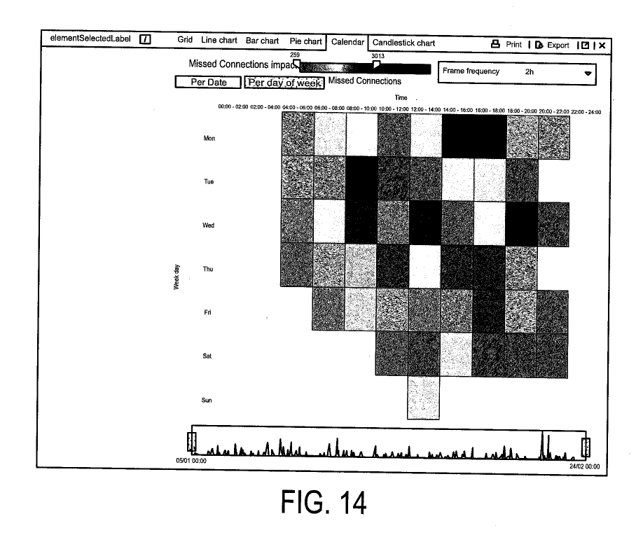

FIG. 13 shows a map view (simplified) of the impact of missed connections on the route and FIG. 14 is a corresponding time series chart view for a stop.

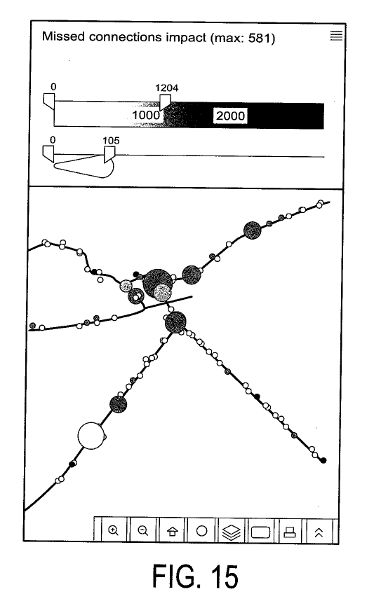

FIG. 15 is a global view of number (circle size) and impact of delay (circle shade) caused by missed connections over a portion of the network. As will be appreciated, the entire network can be shown in a single map view. From the global view of missed connections, it can be observed that the largest quantity of missed connections occurs in hubs of the network where most of the connections take place. However, these stops have an average impact time which limited, due to the fact that quite frequent connections are available at these hubs. From the same map it can be seen that the places with high delays associated with missing connections (dark circles) tend to occur in peripheral areas of the network and, in general, are associated with a limited number of events.

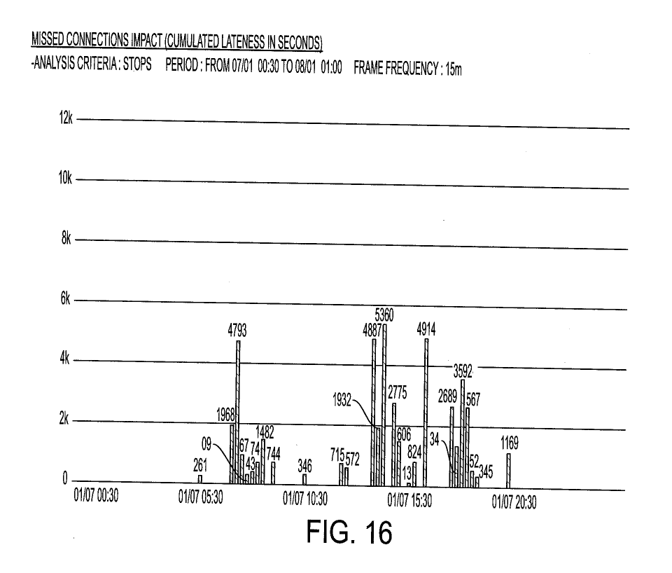

FIG. 16 shows the impact of missed connections at one particular stop over time. It can be observed that the highest cumulated lateness is following the traffic peak hours. However there are some isolated peaks in low traffic hours. These occurrences demonstrate that even a few events in low traffic hours can have a significant effect, because they individually have more impact due to the limited frequency of service at this time.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for computing a multidimensional metric for evaluating reliability of a transportation service, comprising:
collecting transportation data for at least a part of a transportation network, the network including a set of routes that are traversed by vehicles, each route including a set of stops;
for at least one of the stops on the at least one route, computing dimensions of a multidimensional metric for evaluating reliability, the dimensions being selected from:
a) a perceived waiting cost, which is a measure of annoyance caused for a passenger waiting at the stop for a vehicle,
b) a cost of lateness at a final destination, based on a difference between a scheduled arrival time and an actual arrival time, the scheduled arrival time taking into account a theoretical time for making each connection, if any, and
c) an annoyance cost due to a missed connection at the stop, which is computed as a function of a difference between a time of arrival at the final destination of the vehicle that was actually taken by the passenger and the arrival at the final destination of the vehicle that would have been taken, had there not been a missed connection;
generating a representation of at least one of the computed dimensions for at least one of the stops, for at least one of the passengers; and
outputting the representation.

2. The method of claim 1, wherein at least one of the computing dimensions of a multidimensional metric and generating the representation is performed with a processor.

3. The method of claim 1, further comprising computing historical distributions of lateness of vehicles at some of the stops on at least one of the routes, based on scheduled arrival times and determined arrival times and wherein the computing of at least one of the dimensions takes into account the historical distributions of lateness.

4. The method of claim 1, wherein the perceived waiting cost is computed as a function of at least two components selected from:
a) an estimated waiting time component, which is an estimate of the actual time spent waiting at a stop for a vehicle;
b) a budgeted waiting time component, which is a measure of the time a passenger expects to wait when they have arrived at their final destination; and
c) a stress component, which considers stress factors which influence perceived waiting costs.

5. The method of claim 4, wherein the estimated waiting time is computed as EWᵢ=min (0.5 Hᵢ, max ((Vᵢ−Vₚ₁, 0)) , where Hᵢ is the headway for a time interval i, Vᵢ is the variation from the schedule of the service for the interval i; and Vₚ₁ is the p₁^{th} percentile of the distribution of schedule variation for the service.

6. The method of claim 4, wherein the budgeted waiting time component uses a historical distribution of late arrival at the final destination to compute a budgeted weighting time for a passenger to arrive by a selected time at least a threshold proportion of the time.

7. The method of claim 4, wherein computing of the perceived waiting cost comprises, for each passenger starting at the stop, computing an annoyance factor φ as a an aggregate of estimated waiting time EW, budgeted waiting time BW, and stress SC,
φ=[d*EW]+[g*BW]+[SC] (1)
where d and g are weighting coefficients; and
computing the perceived waiting cost as an increasing function of the annoyance factor and a risk aversion coefficient.

8. The method of claim 4, wherein the stress factors are selected from:
a) impact of crowd, which is determined as a function of the number of passengers waiting at the stop;
b) impact of service, which is determined as a function of a scheduled headway between a previous and a next vehicle of the service;
c) impact of time, which is determined as a function of a ratio of current daily travelers to the yearly maximum of daily travelers; and
d) combinations thereof.

9. The method of claim 8, wherein the stress component is computed as an optionally-weighted aggregate of the stress factors, with respective weights a, b, and c:
$$SC = a * N + b * {H}_{th} + c * \frac{CT}{DT}$$
where:
N is number of passengers waiting at the stop in a same time interval,
Hₜₕ is a theoretical headway between a previous vehicle and a next vehicle,
CT is a number of passengers for at least a part of the network in a current time period,
DT is a number of passengers for the at least a part of the network during a predefined time period, and
a, b, c, are weighting coefficients.

10. The method of claim 1, further comprising, aggregating the computed at least one dimension over a set of passengers waiting at the stop in a given time interval.

11. The method of claim 1, wherein the representation is selected from:
a map view which shows a plurality of stops on a route and for each stop, a graphical representation of the computed aggregate of the at least one dimension for the set of passengers; and
a time series chart view which shows changes in at least one of the dimensions over time for at least one of the stops.

12. The method of claim 11, wherein the computed aggregate of the at least one dimension is an average over the set of passengers waiting at the stop in a given time interval and the map view further includes, for each stop, a representation of the number of passengers.

13. The method of claim 12, wherein the computed aggregate is represented by color of a shape shown at the stop and the number of passengers is represented as a size of the shape.

14. The method of claim 1, wherein the generating of the representation comprises generating a graphical representation for display on a display device.

15. The method of claim 1, wherein the collected transportation data comprises, for a plurality of the routes of the network:
a count of passenger boardings for each of a set of stops of a vehicle trip on the route;
a count of passenger alightings for each of a set of stops of the vehicle trip on the route;
a set of passenger journeys from an origin to a destination, each of the passenger journeys including a boarding and an alighting on the route; and
a schedule of vehicle trips.

16. The method of claim 15, wherein one of the count of passenger boardings and the count of passenger alightings is deduced, at least in part, based on the other of the count of passenger boardings and the count of passenger alightings for a different vehicle trip on the route.

17. The method of claim 1, further comprising displaying the representation on a display device.

18. A system for computing a multidimensional metric for evaluating reliability of a transportation service comprising memory which stores instructions for performing the method of claim 1 and a processor in communication with the memory for executing the instructions.

19. A computer program product comprising non-transitory memory which stores instructions which, when executed by a computer, perform the method of claim 1.

20. A system for computing a multidimensional metric for evaluating reliability of a transportation service, comprising:
a data collection component which collects transportation data for at least a part of a transportation network, the network including a set of routes that are traversed by vehicles, each route including a set of stops;
a lateness component which computes distributions of lateness of vehicles at some of the stops on at least one of the routes, based on scheduled arrival times and determined arrival times;
a reliability computation component which, for a plurality of stops on the at least one of the routes, computes dimensions of a multidimensional metric for evaluating reliability, the dimensions comprising:
a) a perceived waiting cost, which is a measure of utility based on the annoyance caused for a passenger waiting at the stop for an expected vehicle,
b) cost of lateness at a final destination, based on a difference between a scheduled arrival time and an actual arrival time, the scheduled arrival time taking into account a theoretical time for making each connection, if any, and
c) an annoyance cost due to a missed connection at the stop, which is computed as a function of a difference between a time of arrival at the final destination of the vehicle that was actually taken by the passenger and the arrival at the final destination of the vehicle that would have been taken, had there not been a missed connection;
a representation generator which generates a representation of at least one of the dimensions for at least one of the stops, for at least one of the passengers and outputs the representation; and
a processor which implements the data collection component, lateness component, reliability computation component, and representation generator.

21. A method for evaluating reliability of a transportation service, comprising:
collecting transportation data for at least a part of a transportation network, the network including a set of routes that are traversed by vehicles, each route including a set of stops, the transportation data including scheduled vehicle trips on the network and passenger data, the passenger data including boarding times and alighting times for passengers at stops on the network;
computing distributions of lateness based on scheduled arrival times and actual arrival times of vehicles at the stops;
for each passenger in a set of passengers, computing a perceived waiting cost at one of the stops, the perceived waiting cost taking into account the computed distributions of lateness, the perceived waiting cost being a function of:
a) an estimated waiting time component, which is an estimate of the actual time spent waiting at a stop for a vehicle, that takes into account whether the stop is an origin of a journey by the passenger or a connecting stop,
b) a budgeted waiting time component, which is a measure of the time a passenger expects to wait when they have arrived at their final destination, and
c) a stress component, which considers stress factors which influence perceived waiting costs;
generating a representation of the perceived waiting cost for at least one of the stops, for the set of passengers; and
outputting the representation.
